(19) United States
(12) Patent Application Publication
(10) Pub. No.: US 2022/0262561 A1
(43) Pub. Date: Aug. 18, 2022

(54) Self-Shielded High Frequency Inductor

(71) Applicants: Massachusetts Institute of Technology, Cambridge, MA (US); The Trustees of Dartmouth College, Hanover, NH (US); Board of Regents, The University of Texas System, Austin, TX (US)

(72) Inventors: Roderick S. BAYLISS, III, San Francisco, CA (US); David J. PERREAULT, Cambridge, MA (US); Charles SULLIVAN, West Lebanon, NH (US); Rachel S. YANG, Leonia, NJ (US); Alex J. HANSON, Austin, TX (US)

(73) Assignees: Massachusetts Institute of Technology, Cambridge, MA (US); The Trustees of Dartmouth College, Hanover, NH (US); Board of Regents, The University of Texas System, Austin, TX (US)

(21) Appl. No.: 17/675,561

(22) Filed: Feb. 18, 2022

Related U.S. Application Data
(60) Provisional application No. 63/150,704, filed on Feb. 18, 2021.

(51) Int. Cl. H01F 27/36; H01F 27/24; H01F 27/28

(52) U.S. Cl. CPC H01F 27/366; H01F 27/2823; H01F 27/24

(57) ABSTRACT

In one aspect, described is a magnetic-core inductor design approach that leverages NiZn ferrites with low loss at RF, distributed gaps and field balancing to achieve improved performance eat tens of MHz and at hundreds of watts and above. Also described is an inductor design which achieves “self-shielding” in which the magnetic field generated by the element is wholly contained within the physical volume of the structure rather than extending into space as a conventional air-core inductor would. This approach enables significant reductions of system enclosure volume and improvements in overall system efficiency.

### CROSS-REFERENCE TO RELATED APPLICATIONS

This application claims the benefit of U.S. Provisional Application Ser. No. 63/150,704, filed on Feb. 18, 2021 the contents of which is incorporated by reference herein in its entirety.

### BACKGROUND

As is known, magnetic components often dominate the size and loss in power electronics. Due to magnetics fundamentals, the performance of magnetic components typically deteriorates as they are made physically smaller. This presents an unfortunate trade-off between power handling capability and size. Given the necessity of magnetics within many power electronics designs, it is increasingly more difficult to meet both system requirements and physical limits. Of particular interest are radio-frequency (RF) power inductors which are critical to many application spaces such as communications, RF food processing, heating, and plasma generation for semiconductor processing. Inductors for high frequency and high power (e.g., tens of MHz and hundreds of watts and above) have traditionally been implemented as air-core solenoids. This approach avoids high-frequency core loss. Such air-core solenoid designs typically have more turns than magnetic-core inductors and thus high copper loss compared with magnetic-core inductors. Such high loss and large size are both major contributors to the overall efficiency and size of some systems.

One additional pitfall of air-core inductors often used in RF systems is the magnetic flux distribution outside of the coils. Without a core piece surrounding the copper coils, flux flows radially away from the inductor by an undesirable distance. Reducing the flux outside of the core can provide significant and desirable performance benefits in some applications. In the RF plasma generation application space, for example, there is a very clear desire to miniaturize the boxes that contain these RF power electronics. Miniaturization decreases floor space occupied by the power electronics thereby potentially increasing factory output efficiency. However, there is a strict requirement that all the power electronics must be placed inside of a metal enclosure in order to reduce electromagnetic interference and loss in surrounding components. Consequently, the ability to reduce the size of these enclosures is typically limited by the size of the inductor.

As is also known, if a metal object is placed perpendicularly to a time-varying magnetic field, eddy currents and loss are generated in the metal. This reduces system efficiency, and practically reduces the inductance of the inductor producing the magnetic fields. This is another fundamental flaw in the coreless inductor: namely, the boxes that surround them must be physically large or significant losses will be incurred.

### SUMMARY

To address the aforementioned issues, described is a “self-shielded” inductor structure capable of achieving high quality factor (or low loss). As used herein, the term “self-shielded” refers to an inductor structure having a small value of magnetic fields external to the physical volume of the structure (i.e., magnetic fields external to the physical volume of the inductor structure are relatively small).

This shielding may be achieved by including both an outer region of distributed gap ferrite pieces and wrapping the structure in a shorted conductive layer. The outer region of ferrite provides a shunt path for flux to flow while the conductive layer acts as a transference, rejecting any additional flux from flowing outside of the structure. Low loss is achieved by: (1) use of field balancing techniques to reduce winding loss; and (2) the use of low-permeability magnetic materials and/or distributed gaps to reduce proximity effect losses that may otherwise occur (e.g. in a typical gapped inductor).

In embodiments, the outer region of distributed gap ferrite pieces may be provided as an outer ring of distributed gap ferrite pieces and the shorted conductive layer may comprise a copper foil, for example. The outer ring of ferrite provides a shunt path for flux to flow while the copper foil acts as a transference, rejecting any additional flux from flowing outside of the structure. In such embodiments, low loss may again be achieved by: (1) use of field balancing techniques to reduce winding loss; and (2) the use of low-permeability magnetic materials and/or distributed gaps to reduce proximity effect losses. In all embodiments described herein, the conductive layer may be provided having any shape, geometry or thickness (or any combination of shapes, geometries or thicknesses) which allow the conductive layer to act as a transference, rejecting any additional flux from flowing outside of the structure of which it is a part.

Structures provided in accordance with the concepts and techniques described herein may also utilize field balancing to reduce winding loss of a magnetic component by better utilizing a surface of an available conductor. Loss within an inner part of a winding is proportional to the magnetomotive force (MMF) drop across a lumped reluctance on the “inside” part of the winding (sometimes denoted herein as R_{center}), while the loss within an outer part of the winding and the shield is proportional to the MMF drop across lumped reluctance on the “outside” part of the winding (sometimes denoted herein as Rₛₕₑₗₗ). By selecting the reluctances in the inner core and outer shell of the magnetic structure properly, one can reduce (and ideally minimize) overall inductor loss (and thus increase, and ideally maximize, quality factor). Low conductor losses can be achieved when the inner core reluctance and the outer shell reluctance are on the same scale. In embodiments, a reduced total loss (and ideally an absolute minimum in total loss) can be found across a range of geometries and permeabilities (e.g., constraining inductance and volume) to obtain an inductor having a reduced (and ideally, minimum) loss characteristic.

A further means of reducing (and ideally, minimizing) loss in structures provided in accordance the concepts and techniques described herein is through the use of distributed gaps in the core and shell, where a substantial portion of the magnetic stored energy are stored within the distributed gaps. The gap and ferrite spacing may be selected to limit proximity effect due to the fringing fields from the distributed gap impinging on the inductor windings, and the net ferrite fraction can be set to determine desired net reluctances of the core and shell structures (and their “effective” permeabilities, μ_{rce} and, μᵣₛₑ). This results in designs have one or both of little fringing flux and/or field balancing to reduce, and ideally minimize, loss. Moreover, structure provided in accordance to the concepts and techniques described herein have operating frequency and current carrying capacity characteristics significantly different than prior art structures. For example, structures provided in accordance the concepts and techniques described herein are capable of operation in the tens (10s) of MHz frequency range (e.g. in the range of about 10 MHz to about 100 MHz) and the tens (10's) of kW power scale (e.g., in the rage of about 10 kW-to about 100 kW).

In embodiments, described structures include turns of a conductor (e.g., copper turns) which substantially fill a window (barring some spacing between each turn and from the end turns to the top and bottom of the ferrite end caps). In practice, one implementation of a single-layer winding is to make it helical in nature.

In one example embodiment, to wind N turns of conductor around a cylindrical (or substantially cylindrical) center post, the window height is preferably larger than (N+1)(turn height)+N (turn gap height)+2(turn to ferrite spacing). This introduces a variable air gap as a function of θ (within a cylindrical coordinate system of the structure) from the end of each turn to the end caps. As the turns are moved upwards, loss within a bottom turn decreases while the loss in a top turn increases. The loss in the middle turns, however, may be mostly unaffected by changes in z-position.

In embodiments, either a helical winding structure or a “Z” winding structure may be used. A “Z” winding structure may be employed where the turns are substantially continuous bands of conductor (e.g., copper) wrapped horizontally then make a vertical jump from one turn to the next thereby forming a Z pattern (or Z-shaped pattern) as one turn turns into the next. This fills more of the window area with copper. In either of these implementations, however, the winding may be wound (e.g., from foil, bar, pipe, wire), cut or etched from a copper cylinder, printed, wound/constructed from a heat pipe formed to the correct shape, etc.

One means for reducing loss at the end-most turns may be provided via the introduction of un-gapped ferrite adjacent to the end regions of the window area. The ferrite provides a lower reluctance path in which flux may flow rather than bypassing the distributed gap and jumping across the air gap in the window. Such an approach adds another free variable into an optimization plane, the height of this un-gapped ferrite hr. In embodiments, this variable may be chosen to be the same for all un-gapped ferrite pieces.

In embodiments, it may be desirable to use a reduced (and ideally, minimum) copper-to-ferrite spacing since this approach reduces fringing field losses induced by ferrite gaps. In embodiments, such a copper-to-ferrite spacing may be s>0.25p (where s is a distance from copper to distributed gap ferrite, in this case radially, and p is a center-to-center spacing of the ferrite pieces). Due to the reduction of fringing field losses induced by ferrite gaps, there is a limit on how small the quantity c-b (where c and b are both numbers having values ranging from 0 to 1 which represent the ratio of center-post and inner shell radius to total radius, respectively) can be for a given number of distributed gaps. Thus there is a tradeoff between manufacturing complexity and physical volume. Similarly, there is a limit to the mechanical rigidity of short, radially large ferrite discs. Additionally, as will be described herein, there exists mechanical considerations such as how to mount the copper foil within the structure or how to expose the inductor terminals to the “outside world” which may limit the proximity of copper to ferrite.

Given these definitions, the structure is now generalizable. That is, given the geometries of the ferrite pieces, number of turns, and permeabilities of each ferrite section. The lossy nature of the copper shield may be modeled with a transference element L_{shield}.

In accordance with one aspect of the concepts and techniques, described is a magnetic-core inductor design approach that leverages ferrites with low loss at RF, distributed gaps and field balancing to achieve improved performance at tens of MHz and at hundreds of watts and above. In embodiments the ferrites may be provided as NiZn ferrites. Also described is an inductor design which achieves “self-shielding” in which the magnetic field generated by the element is substantially contained (and ideally, wholly contained) within the physical volume of the structure rather than extending into space outside of the physical volume of the structure as a conventional air-core inductor would. This approach enables significant reductions of system enclosure volume and improvements in overall system efficiency.

In accordance with a further aspect of the concepts described herein, it has been recognized that performance of the aforementioned RF systems is often limited by the magnetics within them. Although the design of high performing magnetic elements is complicated by high frequency effects, described herein are mechanisms that limit the efficiency of these elements and methodologies to work around these limits to the designer's advantage.

In one embodiment, an example inductor provided utilizing the concepts and techniques described herein exhibited a quality factor that is at least 1100 at 20 Aₚₖ and may be as high as 1600 at 80 Aₚₖ.

Of significance to the development of the design methodologies described herein are the experimental techniques to verify the performance of these magnetic elements in the real world. Given the high levels of performance achieved using the design methodologies described herein, a similarly high performing measurement apparatus is required. A transformer-coupled resonant tank enables the extraction of inductor resistance and thus quality factor at very large drive levels, enabling the next generation of high frequency magnetics. Moreover, an RF probing technique is proposed that can eliminate some of the measurement challenges that were observed in trying to measure the prototype inductor. This technique was validated to be effective, though it will need refinement to be applied at up to full power levels for these designs.

Also described is a fully “self-shielded” inductor. This design approach has the potential to not only significantly reduce system enclosure volume and increase system efficiency, but also enables greater system flexibility as designers are no longer constrained by the large fringing magnetic fields produced by conventional air-core solenoids and the associated coupling with other circuit elements.

It should be understood that although high frequency alternating current (HFAC) inductor design is described herein, after reading the disclosure provided herein one of ordinary skill in the art will recognize extensions of the described concepts and techniques to other magnetic elements such as transformers and inductors which carry both DC and HFAC currents.

In an embodiment, a magnetic core inductor with low loss at radio frequency (RF) comprises a cylindrical body with a first radius; a core section of the cylindrical body positioned at the center of the cylindrical body, the core section having a body that forms a cylinder with a second radius that is smaller than the first radius; a shell ring section of the cylindrical body surrounding the core section, the shell ring section having a body that forms a hollow cylinder having an inner radius that is smaller than the first radius and larger than the second radius; a void between the core section and the shell ring section, the void having a radial width that is a difference between the inner radius of the shell ring section and the second radius; and a conductive layer (or coil) positioned within the void between the core section and the shell ring section. In embodiments, the conductive coil may comprise a copper wire or a copper foil. In embodiments, the conductive layer is provided as a conductive coil. In embodiments, the conductive coil may comprise a multistrand wire or cable (e.g. a Litz wire). In embodiments, the conductive coil may comprise a wire having a rectangular cross-sectional shape (e.g. an Oval wire). In embodiments, the conductive layer may comprise a copper film.

In another embodiment, a magnetic core inductor comprises a cylindrical core section; a shell ring section having a body in the shape of a hollow cylinder, the shell ring section positioned around the cylindrical core section to form a gap between the cylindrical core section and the shell ring section; a top section forming a top wall of the gap; a bottom section forming a bottom wall of the gap; and an electrical conductor positioned within the gap.

In another embodiment, a magnetic core inductor comprises a cylindrical core section; a shell ring section having a body in the shape of a hollow cylinder, the shell ring section positioned around the cylindrical core section to form at least one gap between the cylindrical core section and the shell ring section; a first cylindrical section forming a top wall of a first gap of the at least one gap; and a second cylindrical section forming a bottom wall of the first gap of the at least one gap.

In another embodiment, a magnetic core inductor comprises a cylindrical core section; a shell ring section having a body in the shape of a hollow cylinder, the shell ring section positioned around the cylindrical core section to form a gap between the cylindrical core section and the shell ring section; a top section having a first recess; a bottom section; and an electrical conductor positioned within the gap; wherein the recess forms a portion of the gap.

In another embodiment, a magnetic core inductor comprises a rectangular modular (RM) core section; a shell section disposed around the RM core section to form a gap between the RM core section and the shell section; a top section having a first recess; a bottom section; and an electrical conductor positioned within the gap wherein the recess forms a portion of the gap.

In another embodiment, a magnetic core inductor comprises an EI core section; a shell section disposed around the EI core section to form a gap between the EI core section and the shell section; a top section having a first recess; a bottom section; and an electrical conductor positioned within the gap wherein the recess forms a portion of the gap.

In another embodiment, a magnetic core inductor comprises an EE core section; a shell section disposed around the EE core section to form a gap between the EE core section and the shell section; a top section having a first recess; a bottom section; and an electrical conductor positioned within the gap wherein the recess forms a portion of the gap.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a polar cutaway view of a self-shielded Inductor;

FIG. 2 is a schematic diagram of a self-shielded inductor magnetic circuit model;

FIG. 3 is a plot of z-Position of the inductor's windings within the Window vs. copper loss;

FIG. 4 is a polar cutaway view of a self-shielded Inductor which includes an un-gapped Ferrite and the top and bottom ends of the winding window;

FIG. 5 is a plot of copper loss by turn vs. z-offset with an arbitrary selection of un-gapped ferrite at the ends of the winding window; and

FIG. 6 is a cutaway view of a distributed-gap inductor with a conductive outer shell to reject flux that would flow outside of the physical structure's volume;

FIG. 7A is an isometric view of a portion of a rectangular modular (RM) core;

FIG. 7B is an isometric view of a distributed-gap inductor having an RM core and conductive outer shell to reject flux that would flow outside of the physical structure's volume;

FIG. 8A is an isometric view of a portion of an E core which may be used in a distributed-gap inductor having either an EE core or an EI core;

FIG. 8B is a cross-sectional view of a distributed-gap inductor having an EE core; and a conductive outer shell to reject flux that would flow outside of the physical structure's volume

FIG. 8C is a top view of the distributed-gap inductor of FIG. 8B.

### DETAILED DESCRIPTION

In one aspect, described is a magnetic-core inductor design approach that leverages NiZn ferrites having low loss at radio frequencies (RF), distributed gaps and field balancing to achieve improved performance at tens of MHz and at hundreds of watts and above. In one example embodiment, the magnetic-core inductor described herein achieves a quality factor of Q˜>1100 in a 13.56 MHz, 580 nil, 80 Aₚₖ magnetic-core inductor design which is a significant improvement over Q˜600 achieved by conventional air-core inductors of similar volume and power rating.

It should be appreciated that to promote clarity in the description of the concepts sought to be protected, reference is sometimes made herein to embodiments of inductors which are cylindrical in shape. After reading the description provided herein, those of ordinary skill in the art will appreciate that the concepts described herein are equally applicable to inductor designs which may not be considered cylindrical (e.g., inductor designs may be considered only somewhat cylindrical or not cylindrical). For example, the concepts described herein may be used with structures/embodiments including but not limited to rectangular modular (RM) cores, EI cores and EE cores. While such structures may not be considered cylindrical or fully cylindrical, it is recognized that such structures (and other structures) may nevertheless benefit from the concepts, structures and techniques described herein.

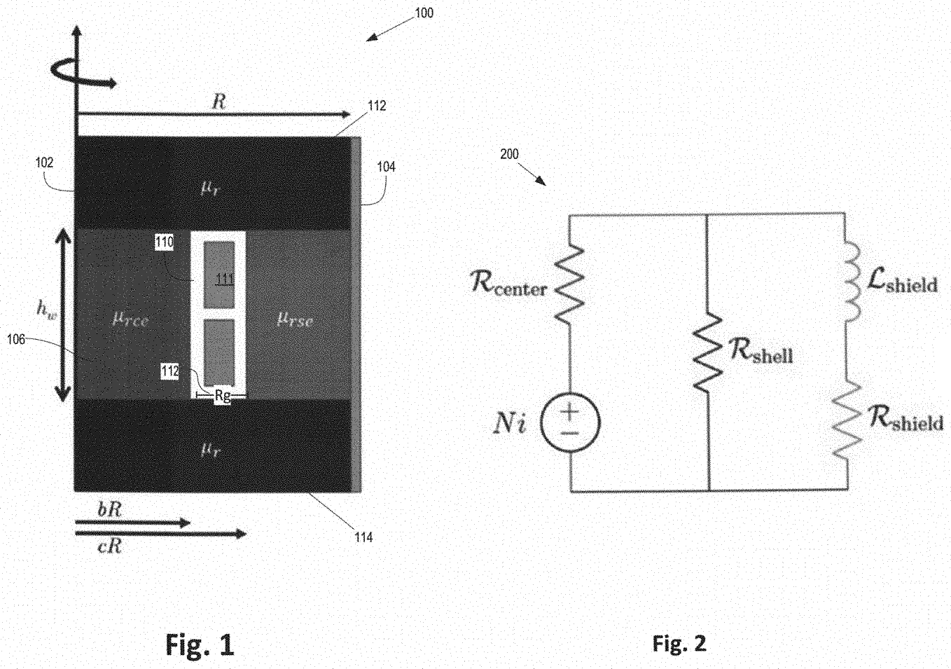

Referring now to FIG. 1, a self-shielded inductor 100 includes a “pot core” cylindrical structure 102 having a copper foil 104 disposed thereabout. The “pot core” cylindrical structure 102 has a radius R (assuming the width of a copper foil as negligible). A radius bR (where b is a number between 0 and 1) represents the radius of a center post 106. The center post 106 has a relative, effective permeability denoted μ_{rce}. A radius cR (where c is a number between 0 and 1) represents an inner radius of a shell ferrite ring 108. A window 110 (i.e. a void between the center post 106 and the shell ferrite ring 108) in which the copper turns 111 are placed has a height hw. As can be seen in FIG. 1, the center post 106 and shell ferrite ring 108 sections are implemented with a distributed gap 112 having a width Rg. A top cap 112 having a cylindrical shape forms a top wall of the window 110, and a bottom cap 114 also having a cylindrical shape forms a bottom wall of the window 110.

In embodiments, the ferrite sections may comprise the same (or substantially, the same) material as the center post and shell ring. In some embodiments, the ferrite sections may be provided as solid pieces (or “chunks”) of ferrite while the center post and shell ring may comprise alternating layers of ferrite and plastic, forming the distributed gap.

In embodiments, if low-loss, low permeability magnetic materials are used, the center post and outer shell may be implemented as a solid chunk of such low-permeability material and the top and bottom “end caps” as a chunk of higher permeability material.

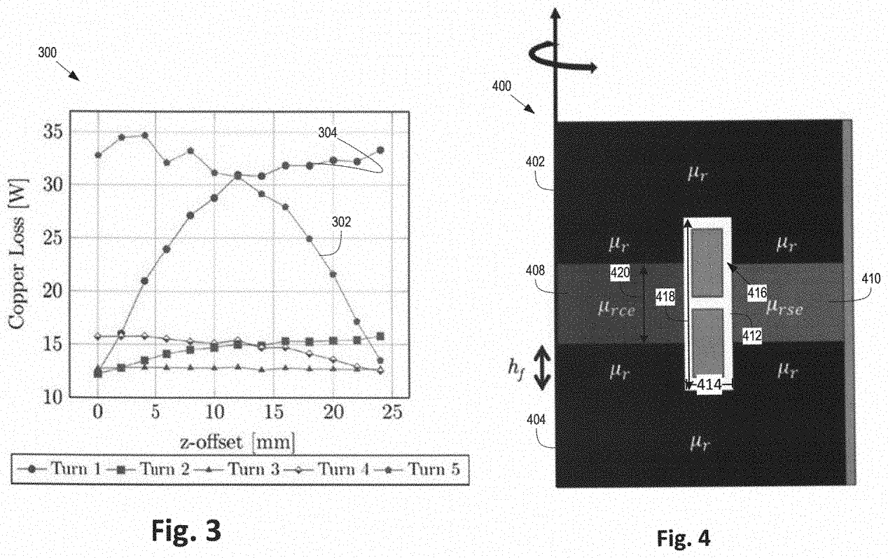

Referring briefly to FIG. 2, a self-shielded inductor which may be the same as or similar to the self-shielded inductor 100 described above in conjunction with FIG. 1 and provided in accordance with the concepts and techniques described herein, may be modeled via circuit 200. Model circuit 200 may include a source Ni that represents the MMF source of the windings across the inductor 100. The reluctance R_{center} represents the reluctance of center post 106, a shell reluctance Rₛₕₑₗₗ represents the reluctance of shell ferrite ring 108, and a shield reluctance R_{shield} represents the reluctance of copper foil 104 In the model circuit 200 of FIG. 2, the lossy nature of the copper shield is modeled with a transference element L_{shield}.

The structure of inductor 100 utilizes field balancing to reduce the winding loss of the magnetic component by better utilizing the surface of the available conductor. For example, the loss within the inner part of the winding is proportional to the magnetomotive force (MMF) drop across R_{center} while the loss within the outer part of the winding and the shield is proportional to the MMF drop across Rₛₕₑₗₗ. By selecting the reluctances in the inner core and outer shell of the magnetic structure properly, one can reduce (and ideally, minimize) overall inductor loss and thus increase (and ideally, maximize) quality factor.

Low conductor losses can be achieved when the inner core reluctance and the outer shell reluctance are on the same scale. An absolute minimum in total loss can be found through a brute force optimization across the geometries and permeabilities given above (constraining inductance and volume) and thus, an inductor which exhibits reduced (and ideally, minimum) loss can be designed.

Referring again to FIG. 1, a further means of reducing (and ideally, minimizing) loss in a structure such as the structure in FIG. 1, is through the use of distributed gaps in the core and shell, where a substantial portion of the magnetic stored energy are stored within the distributed gaps. The gap and ferrite spacing may be selected to limit proximity effect due to the infringing fields from the distributed gap impinging on the inductor windings, and the net ferrite fraction can be set to determine desired net reluctances of the core and shell structures (and their “effective” permeabilities, μ_{rce} and, μᵣₛₑ).

In contrast to conventional structures, distributed gap inductors provided in accordance with the concepts and techniques described herein reduce (and ideally minimize significant fringing flux and/or utilize field balancing to reduce (and ideally, minimize) loss. Moreover, both the operating frequency and current carrying capacity of distributed gap inductors provided in accordance with the concepts and techniques described herein are significantly different than conventional prior art inductors since the structures provided in accordance with the concepts and techniques described herein excel in the 10s of MHz and kW power scale, for example.

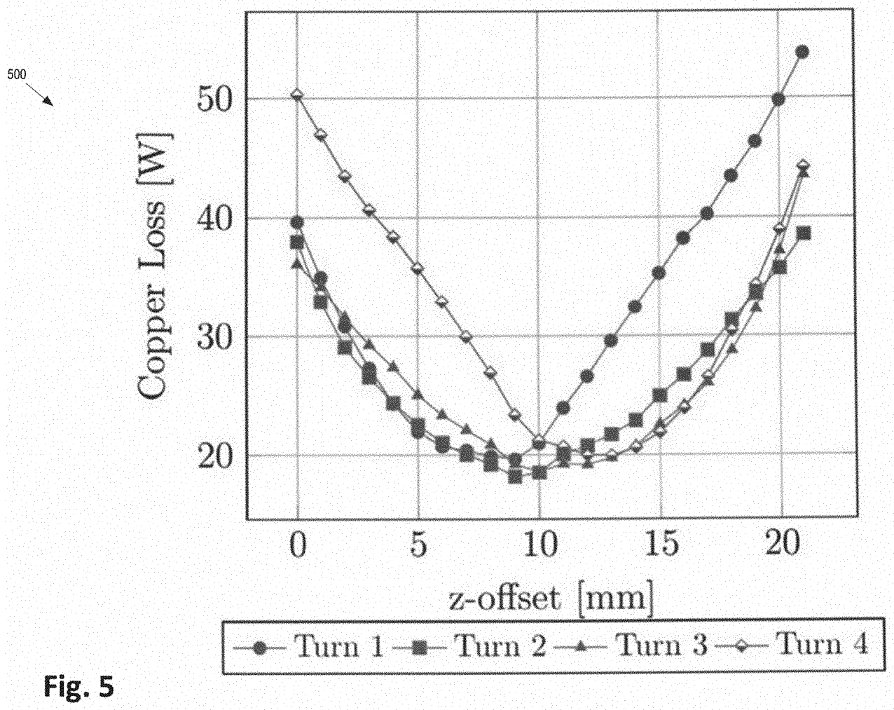

In the structure illustrated In FIG. 1, the copper turns 111 are shown to substantially fill the window 110 (barring small spacing between each turn and from the end turns to the top and bottom of the ferrite end caps). In at least some practical embodiments, the single-layer winding is helical around the center post. To wind N turns of conductor around a cylindrical center post, the window height must be larger than (N+1)(turn height)+N (turn gap height)+2(turn to ferrite spacing). This introduces a variable air gap 112 as a function of θ (within the cylindrical coordinate system of the structure) from the end of each turn to the end caps. A 2-D ANSYS simulation was developed to investigate this effect, where the z-location of the turn within the window (z-offset) was varied, equivalent to sweeping θ in a 3-D structure. Results of the simulation are illustrated in FIG. 3.

Referring now to FIG. 3, a plot 300 of copper loss (in watts) vs z-offset illustrates copper loss by turn and sensitivity to z-Position in a window. As can be seen from FIG. 3, as a vertical position of a wire within the window is varied, the reluctance of an air gap at either end of the turns changes, inducing variable copper loss. As illustrated in FIG. 3, as the turns are moved upwards, the loss within the bottom turn (represented by curve 302) decreases while the loss in the top turn (represented by curve 304) increases. The loss in the three middle turns however, are mostly unaffected by changes in z-position. As can be seen from FIG. 3, the overall copper loss is a maximum at a z-offset of 12 mm.

It should, of course, be appreciated that other winding structures may be employed. For example, rather than using a helical winding structure, a “Z” winding structure can instead be employed where the turns are mostly continuous bands of conductor (e.g., copper) wrapped horizontally then make a sudden vertical jump from one turn to the next, forming a Z pattern as one turn turns into the next. This fills more of the window area with copper compared with a helical winding structure, for example. However, this approach suffers from manufacturing complexity and potentially adverse high frequency effects. In either of these implementations, however, the winding may be wound (e.g., from foil, bar, pipe), cut or etched from a copper cylinder, printed, wound/constructed from a heat pipe formed to the correct shape, etc.

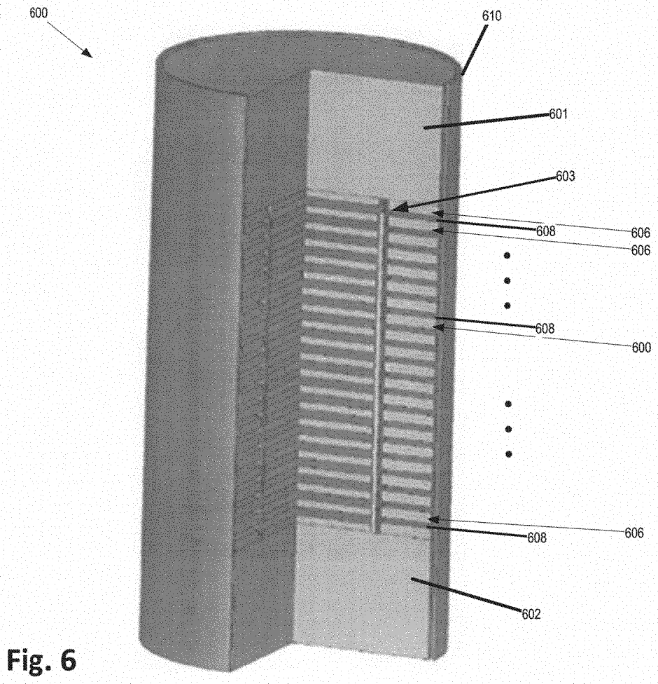

Referring now to FIG. 4 a self-shielded inductor 400 has an un-gapped ferrite sections 402, 404. The inductor 400 includes a center core section 408 having a cylindrical shape. A shell ring section 410 has a hollow cylinder shape and surrounds the center core section 408. A window 412 (i.e. gap) with width 414 is formed between the core section 208 and the shell ring section 410.

In embodiments, the ferrite sections 402, 404 may include a recess (e.g. recess 416 in ferrite section 402). The recess 416 may form the top portion of the window 412, resulting in the window having a height 418 that is greater than the height 420 of the center core section 408 and/or the shell ring section 410. As illustrated in FIG. 4, the ferrite sections 402, 404 provide a lower reluctance path for flux to flow rather than bypassing the distributed gap and jumping across the window 412. This structure adds another free variable into the optimization plane, h_{f} (chosen to be the same for all four (4) pieces, in this example).

The four (4) pieces mentioned above, refer to the pieces of ferrite on the end caps that extend into the winding window. Comparing FIG. 1 to FIG. 4, in FIG. 1 the end caps are solid cylinders, to construct the inductor of FIG. 4, one could add a cylinder of solid material (i.e. not gapped) to the top and bottom and a hollow cylinder on the shell. So in total the structure would likely have two solid cylinders forming the end cap, two smaller solid cylinders to form half of the new window with “recess” and two solid hollow cylinders to complete the window with a recess. Finally, the low permeability distributed gap can be constructed just as the inductor in FIG. 1 to finish the structure.

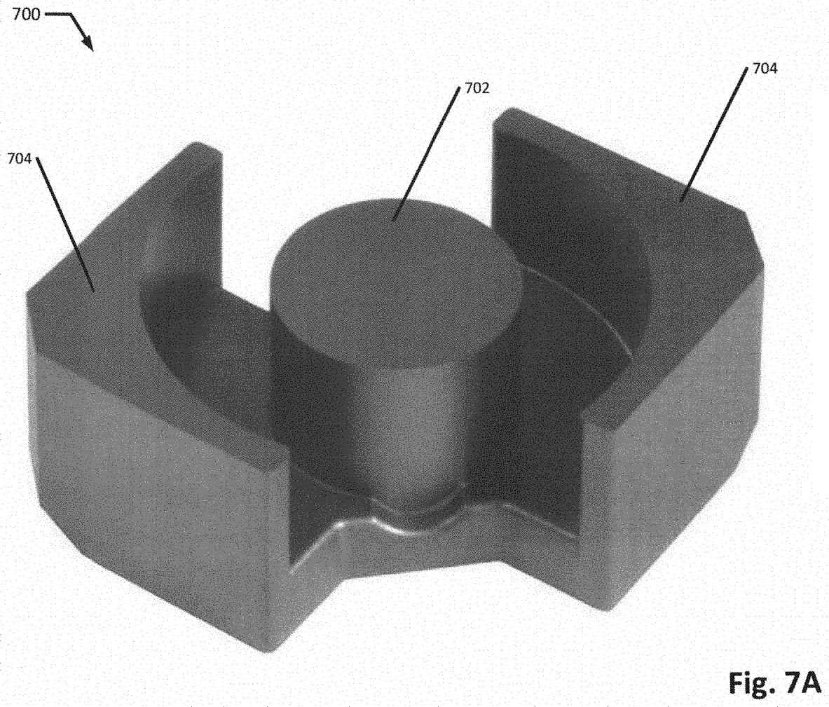

Referring now to FIG. 5, a plot 500 of copper loss vs. z-offset illustrates a copper loss by turn and sensitivity to z position in a window having un-gapped ferrite added in the window. The introduction of un-gapped ferrite into the window area provides a low reluctance path in which flux may flow. Thus, rather than shunting across the air gap, flux can continually flow through the ferrite, thereby reducing adverse interaction between window flux and current within the windings. As can be seen from FIG. 5, the overall copper loss is reduced (and ideally minimized) at z-offset=10 mm;

In the example of FIG. 5, h_{f} was set to 0.375 times the height of a single turn (in this case each piece of ferrite in the window area was 7.14 mm tall). Adding the un-gapped ferrite into the window turns the loss vs. position relationship from one that is maximal in the middle of the Z offset sweep to one that is minimal, indicating that there is a strong relationship between this added ferrite piece and the end turn copper loss. The design used to generate the data in FIG. 5 had significantly fewer gaps (10 vs. 100) and a larger window so it is unfair to do a direct 1:1 comparison of the losses in this design with that shown in FIG. 3, but the benefit of the approach is nonetheless clear.

In embodiments, a minimum copper-to-ferrite spacing (i.e. distributed gap turn spacing) of s>0.25p (where s is distance from copper to distributed gap ferrite, in this case radially, and p is the center-to-center spacing of the ferrite pieces) may be used for reducing fringing field losses induced by the ferrite gaps. Due to this, there is a limit on how small the quantity (c-b), where c and b represent the ratio of center-post and inner shell radius to total radius, respectively and where c and b are both numbers having values between 0 and 1, can be for a given number of distributed gaps). If (c-b) is too small, there will be insufficient width to place the copper windings, first incurring large fringing losses then manufacturing impossibility. If b is too large relative to c, the core loss within the shell and copper loss in the shield winding may be unreasonably high. Conversely if c is too large relative to b, the copper loss within the winding and core loss within the center post may also be unreasonably high. Thus, a tradeoff exists between manufacturing complexity and physical volume. Similarly, there is a limit to the mechanical rigidity of short, radially large ferrite discs. Additionally, as will be discussed, mechanical considerations such as how to mount the copper foil within the structure or how to expose the inductor terminals to the “outside world” may limit the proximity of copper to ferrite.

Given the above definitions, the structure may be generalizable. That is, given the geometries of the ferrite pieces, number of turns, and permeabilities of each ferrite section. The lossy nature of the copper shield may be modeled with a transference element, denoted L_{shield} (FIG. 2). The inductor structure is fully defined (barring the turn spacing), and able to be tested in finite element analysis (FEA) software. However, doing rapid design iterations in these types of software can be slow. To solve this, first principle loss and inductance models can be used to enable a brute force search over the solution space. One goal of such a brute force search is to minimize total loss subject to inductance and volume constraints. Loss in the copper windings and shield is calculated based on the magnetomotive force (MMF) present on either side of the winding. Assuming that the shield's transference perfectly rejects all flux and that all conduction occurs within a skin Depth™:

R_{center}=h_{w}μ_{rce}μ₀πb₂R₃ (1)

R_{center}=h_{w}μ_{rce}μ₀πR₂(1−c₂) (2)

Fᵢₙₙₑᵣ=R_{center}R_{center}+RₛₕₑₗₗNI (3)

P_{wire,inner}=12(ρ_{cu}2πbRhσ)F₂ᵢₙₙₑᵣ (4)

Fₒᵤₜₑᵣ=NI=Fᵢₙₙₑᵣ (5)

P_{wire,outer}=12(ρ_{cu}2πbRhσ)F₂ₒᵤₜₑᵣ (6)

P_{shield}=12(ρ_{cu}2πbRhσ)F₂ₛₕₑₗₗ (7)

Where Fᵢₙₙₑᵣ is the MMF drop across R_{center} and Fₒᵤₜₑᵣ is the MMF drop across Rₒᵤₜₑᵣ. Core loss is then calculated using the Steinmetz parameters of the material and flux density within:

Bᵢₙₙₑᵣ=LINπb₂R₂ (8)

Bₛₕₑₗₗ=LINπ(1−c₂)R₂ (9)

Where I is the peak sinusoidal current carried by the inductor. Using the fraction of ferrite Ff as defined above, an effective Steinmetz coefficient C_{m,eff}=f_{f}cₘ models the layering of ferrite in the center-post and shell:

P_{core,center}=f_{f,center}Cₘf_{α}B_{β}_{_{center}}πb₂R₂h_{w} (10)

P_{core,shell}=f_{f,shell}Cₘf_{α}B_{β}_{ₛₕₑₗₗ}π(1−c₂)R₂h_{w} (11)

Where Cₘ, α and β are the Steinmetz coefficients of the magnetic material to be used. For Fair-rite 67, the Steinmetz coefficients obtained were Cₘ=1.78×10₋₆, α=2.202 and, β=2.118. Finally, loss in the end caps is estimated using the mean radius of the end cap:

B_{end cap}=LINπRhₑ (12)

P_{core,end caps}=2Cₘf_{α}B_{β}_{_{end cap}}πR₂hₑ (13)

Where hₑ is the height of a single end cap. The last equations required for scripting are the two constraints of inductance and volume as a function of the aforementioned parameters. This can be calculated using our simple magnetic circuit model:

L=N₂R_{center}+Rₛₕₑₗₗ+2R_{endcap} (14)

volume=πR₂(2hₑ+h_{w}) (15)

Thus one is now able to (ideally) minimize:

Loss=P_{core,center}+P_{core,shell}+P_{wire,inner}+P_{wire,outer}+P_{sheild} (16)

as a function of the parameters that fully define the inductor as described above. A search algorithm (e.g. a MATLAB script) may be used to iterate over these parameters to determine a design that minimizes the loss of the inductor subject to inductance and volume constraints. In addition to sweeping the geometries mentioned above, the MMF percentage of the center-post (i.e. F_{center}NI) may be swept. A higher center-post MMF percentage reduces loss in the shield and the shell ferrite but increases loss on the inner part of the winding.

In some un-shielded design embodiments, the optimal center-post to shell MMF percentage is about 50%. However, with the introduction of the shield losses, the optimal balance may be closer to about 70%.

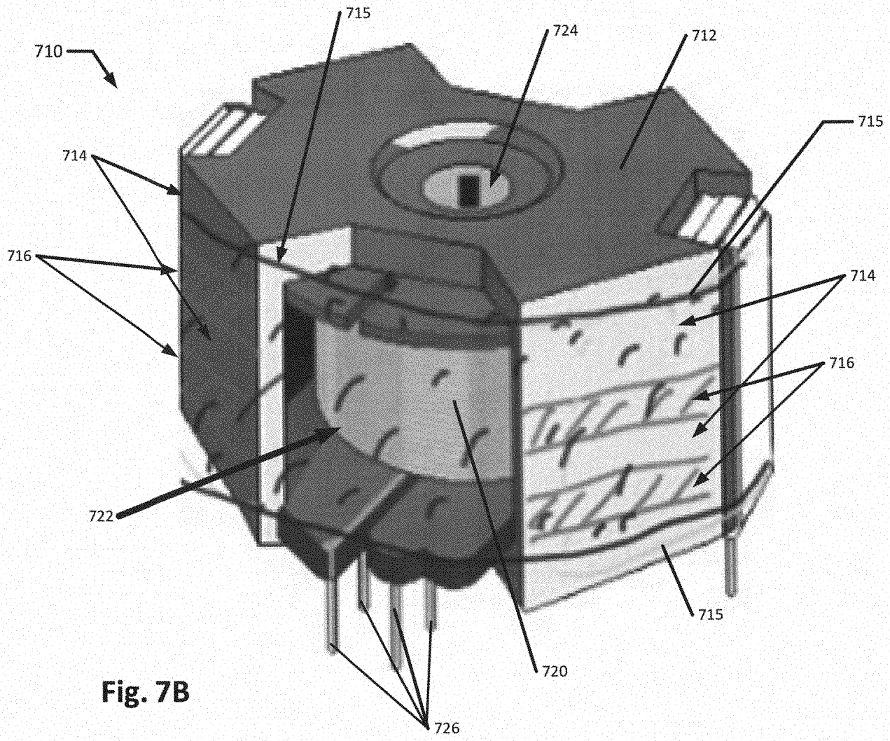

Referring now to FIG. 6, an example distributed-gap inductor 600 includes first and second un-gapped ferrite sections 601, 602. In this example, un-gapped ferrite section 601 forms a top end cap and un-gapped ferrite section 602 forms a bottom end cap. Disposed between the top and bottom end caps 601, 602 are alternating layers of ferrite and gap to form a center core section 603. In embodiments, the alternating layers of ferrite and gap which form the center core section comprise nonmagnetic materials. In embodiments, the nonmagnetic materials may comprise polypropylene. Also disposed between the top and bottom end caps 601, 602 are alternating layers of ferrite and gap 606 which form a shell core section. Reference numeral 608 represents air gaps which model a nonmagnetic material in practical implementations. In embodiments, the alternating layers of ferrite and gap which form the shell core section may comprise nonmagnetic materials. In embodiments, the nonmagnetic materials may comprise polypropylene. A copper foil 610 is disposed about the shell, center core section and top and bottom end caps

In this example embodiment, the gaps are distributed to ideally optimize inductor performance. It should be appreciated that in other embodiments, the gaps in the center core section and the shell section may be evenly distributed. In other embodiments, the gaps may not be evenly distributed. The particular distribution of gaps to use in any particular application may be determined empirically, analytically or by using a combination of empirical and analytic techniques. It should also be appreciated that in embodiments, the gaps in the center core section may be different that the gaps in the shell section. In embodiments, the gaps in the center core section may be the same as the gaps in the shell section.

In the example embodiment of FIG. 6, distributed-gap inductor 600 may be constructed with parameters equal to or near the following. The inductance may be constrained to about 500 nH and the total volume may be constrained to about 1×10⁴ m³. In this example, Fair-rite 67 is used as the core material. Other materials may, of course, also be used. The number of gaps may be about 20. The window width (i.e. R(c−b)) may have a minimum value of about 3.09 mm and the turn-to-turn spacing may be about 1 mm. The outer radius of the ferrite may be about 43 mm, the center post radius may be about 23.65 mm. The inner radius of the shell ferrite may be about 26.74 mm (corresponding to b=0.55 and c=0.62). The center post distributed gap may be made up of 21 about pieces of ferrite that are about 2.36 mm tall with center-to-center spacing of about 4.89 mm, while the shell distributed gap may be made of about 21 pieces of ferrite that are about 3.27 mm tall with center-to-center spacing of about 4.84 mm. The endcaps may be each be about 36 mm tall, yielding a total height of about 172.15 mm. The total volume of the structure may be about is 0.001 m³. The center-post MMF percentage is about 73.75%. The coil may be constructed of 4 turns copper, about 51 μm thick and about 23.79 mm tall with a center to-center spacing of about 24.79 mm. The skin depth of copper at 13.56 MHz and room temperature may be about 17.7 μm. Thus, to increase (and ideally, maximize) the ferrite area (to reduce flux density and thus core loss) a thin copper foil may be used (e.g. 2 mil copper foil).

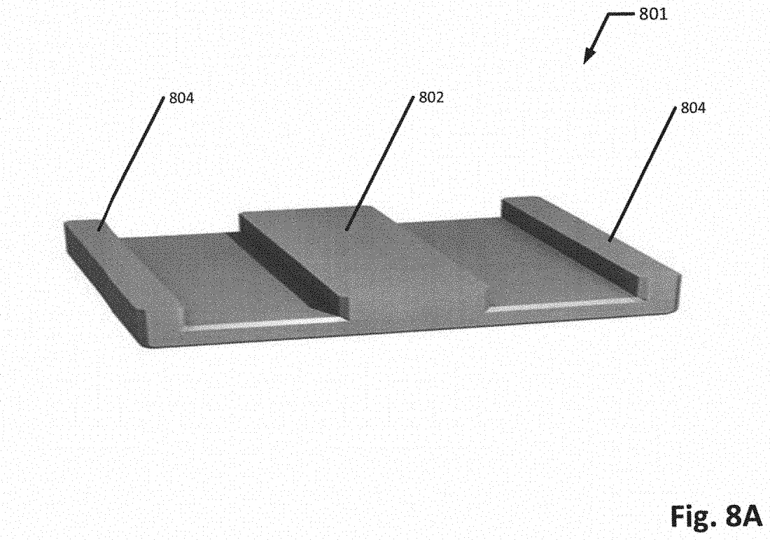

Referring now to FIG. 7A, a portion of a rectangular modular (RM) core 700 includes a cylindrical regions 702, 704. It is noted the cylindrical regions need not be fully filled with magnetic material.

Referring now to FIG. 78, an example distributed-gap inductor 710 includes a rectangular modular (RM) core 712 having a plurality of spaced (or “gapped) ferrite sections 714. In this example, distributed-gap inductor 710 comprise two ferrite pieces 714 disposed between top and bottom end caps of the RM core.

In embodiments, the layers of ferrite 714 may have nonmagnetic materials 716 disposed therebetween resulting in alternating layers of ferrite 714 and non-magnetic material. In embodiments, the nonmagnetic materials may comprise polypropylene.

A conductor 715 is wrapped or otherwise disposed about the plurality of spaced (or “gapped”) ferrite sections 714 (and non-magnetic materials, if any).

A conductor 720 is wrapped or otherwise disposed about a coil former (or bobbin) 722.

The distributed-gap inductor 710 further comprises an adjusting screw 724 and pins 726 as is generally known.

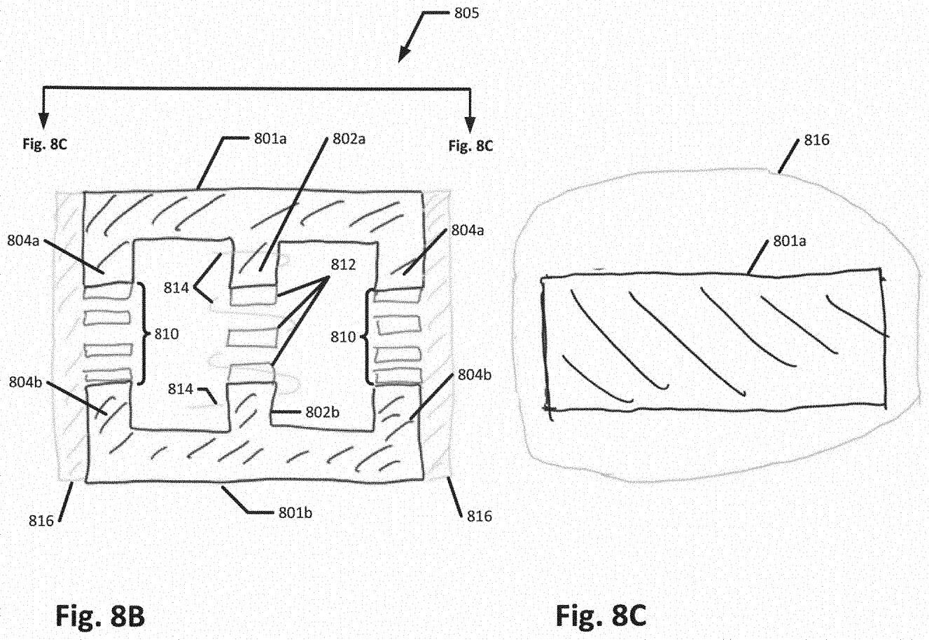

Referring now to FIG. 8A, an “E” portion 801 of a core which may be used in a distributed-gap inductor having either an EE core or an EI core. E” portion 801 comprises a center post 802 having a substantially rectangular shape and a pair of legs 804 each of the legs also having a substantially rectangular shape.

Referring now to FIGS. 8B, and 8C in which like elements of FIG. 8A are provided having like reference designations, an example distributed-gap inductor 805 comprises an EE core provided from a pair of E sections 801a, 801b. Each E section comprises a center post 802a, 802b having a substantially rectangular shape and a pair of legs 804a, 804b with each of the legs also having a substantially rectangular shape.

A plurality of spaced (or “gapped” or “distributed”) ferrite pieces 810 (here, four pieces) are disposed between respective legs 804a, 804b. In embodiments, the layers of ferrite 810 may have nonmagnetic materials disposed therebetween resulting in alternating layers of ferrite 810 and non-magnetic material. In embodiments, the nonmagnetic materials may comprise polypropylene.

Distributed-gap inductor 805 further comprises a plurality of spaced (or “gapped”) ferrite pieces 812 (here, three pieces) disposed between respective center posts 802a, 802b. The alternating layers of ferrite 812 and gap form a center or core section. In embodiments, nonmagnetic materials may be disposed between the ferrite layers 812 resulting in alternating layers of ferrite 812 and non-magnetic material. In embodiments, the nonmagnetic materials may comprise polypropylene.

A conductor 814 (e.g. a conductive coil or wire 814 or winding) is disposed about the center posts 802a, 802b and ferrite pieces 812. In embodiments, the conductive coil 814 may comprise a copper wire or a copper foil. In embodiments, the conductive coil may comprise a multistrand wire or cable (e.g., a Litz wire). In embodiments, the conductive coil may comprise a wire having a rectangular cross-sectional shape (e.g., an Oval wire).

A conductive layer 816 is disposed about the EE core. In embodiments, the conductive layer may comprise a copper film. It should be appreciated that in preferred embodiments, conductive layer 816 is in physical contact with surfaces of respective ones of E sections 801a, 801b (e.g., in physical contact with leg surfaces 804a, 804b of respective ones of E sections 801a, 801b as most clearly shown in FIG. 81). Conductive layer 816 also covers distributed ferrite pieces 810 (and may be in physical contact with surface of distributed ferrite pieces 810). It should be appreciated that in all embodiments described herein, the conductive layer (e.g., conductive layer 816 in FIGS. 88, 8C) may be provided having any shape, geometry or thickness (or any combination of shapes, geometries or thicknesses) which allow the conductive layer to function as described herein (e.g., which allows the conductive layer to act as a transference, rejecting any additional flux from flowing outside of the structure of which it is a part).

The structure of FIGS. 8A-8C, thus results in a self-shielded inductor structure capable of achieving high quality factor (or low loss). The shielding characteristic is achieved, at least in part, by including the outer region of distributed gap ferrite pieces 810 and wrapping the structure in a shorted conductive layer 816. The outer region of ferrite provides a shunt path for flux to flow while the conductive layer acts as a transference, rejecting any additional flux from flowing outside of the structure. Low loss may be achieved by: (1) use of field balancing techniques to reduce winding loss; and (2) the use of low-permeability magnetic materials and/or distributed gaps to reduce proximity effect losses that may otherwise occur (e.g. in a typical gapped inductor). Various embodiments of the concepts, systems, and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure “A” over element or structure “B” include situations in which one or more intermediate elements or structures (e.g., element “C”) is between element “A” and element “B” regardless of whether the characteristics and functionalities of element “A” and element “B” are substantially changed by the intermediate element(s).

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a method, article, or apparatus that comprises a list of elements is not necessarily limited to only those elements but can include other elements not expressly listed or inherent to such method, article, or apparatus.

Additionally, the term “exemplary” is used herein to mean “serving as an example, instance, or illustration.” Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment,” “an embodiment,” “an example embodiment,” or variants of such phrases indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection knowledge of one skilled in the art to affect such feature, structure, or characteristic in connection with other embodiments whether or not explicitly described.

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” surface can become a “lower” surface simply by turning the object over. Nevertheless, it is still the same surface and the object remains the same. Also, as used herein, “and/or” means “and” or “or”, as well as “and” and “or.” Moreover, all patent and non-patent literature cited herein is hereby incorporated by references in its entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter. In particular, the concepts described herein may be used in inductor designs which may be cylindrical as well as inductor designs which may not be considered cylindrical (e.g., inductor designs may be considered only somewhat cylindrical or not cylindrical). Examples of designs which may not be considered cylindrical include designs comprising RM cores or EI cores (e.g. an EI core having rectangular legs and a rectangular center post). While such structures may not be considered fully cylindrical, it is recognized that such structures (and other structures) may nevertheless could benefit from the concepts, structures and techniques described herein.

Accordingly, although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A self-shielded high frequency inductor comprising:
a ferrite core having one of a: cylindrical shape, an RM shape, an EE shape and EI shape;
an outer region comprising a plurality of distributed gap ferrite pieces disposed about a central portion of the core section; and
a conductive layer disposed about the ferrite core region and the plurality of distributed gap ferrite pieces wherein the outer region of distributed gap ferrite pieces are configured to provide a shunt path through which flux may flow and wherein the conductive layer is configured to substantially prevent flux which is not flowing through the shunt path from flowing outside of the magnetic core inductor.

2. The self-shielded high frequency inductor of claim 1 wherein the outer region of distributed gap ferrite pieces may be provided as an outer ring of distributed gap ferrite pieces.

3. The self-shielded high frequency inductor of claim 1 wherein the conductive layer comprises one of: a wire; a copper wire; a wire having a rectangular cross-sectional shape; a copper foil; a multistrand wire; a multistrand cable; and a copper film.

4. The self-shielded high frequency inductor of claim 1 wherein the ferrite core is provided having a cylindrical shape and the self-shielded high frequency inductor further comprises:
a cylindrical body with a first radius with the ferrite core disposed at the center of the cylindrical body, the ferrite core having a body that forms a cylinder with a second radius that is smaller than the first radius.

5. The self-shielded high frequency inductor of claim 4 wherein the outer region is provided as a shell ring section of the cylindrical body surrounding the core section, the shell ring section having a body that forms a hollow cylinder having an inner radius that is smaller than the first radius and larger than the second radius;
a void between the ferrite core and the shell ring section, the void having a radial width that is a difference between the inner radius of the shell ring section and the second radius; and
a conductive coil positioned within the void between the core section and the shell ring section.

6. The self-shielded high frequency inductor of claim 1 wherein the ferrite core is provided having an RM shape.

7. The self-shielded high frequency inductor of claim 1 wherein the ferrite core comprises at least one E-shaped section having a center post and a pair of legs and a plurality of spaced ferrite pieces are disposed between the center post and a second surface.

8. The self-shielded high frequency inductor of claim 7 wherein the spaced ferrite pieces having nonmagnetic materials disposed therebetween to provide alternating layers of ferrite and non-magnetic material.

9. The self-shielded high frequency inductor of claim 8 wherein the nonmagnetic materials comprise polypropylene.

10. The self-shielded high frequency inductor of claim 1 wherein:
the ferrite core is provided having an EE shape provided from first and second E-shaped sections with each E-shaped section having a center post and a pair of legs;
the E-shaped sections are disposed such that center post and legs of each E-shaped section face each other;
the outer region comprised of the plurality of distributed gap ferrite pieces are disposed between the legs of the E-shaped sections;
the self-shielded high frequency inductor further comprises:
a plurality of spaced ferrite pieces disposed between the respective center posts of the first and second E-shaped sections.

11. The self-shielded high frequency inductor of claim 10 wherein the spaced ferrite pieces disposed between the respective center posts have nonmagnetic materials disposed therebetween to provide alternating layers of ferrite and non-magnetic material.

12. The self-shielded high frequency inductor of claim 10 wherein the spaced ferrite pieces disposed between the respective legs have nonmagnetic materials disposed therebetween to provide alternating layers of ferrite and non-magnetic material.

13. The self-shielded high frequency inductor of claim 11 wherein the nonmagnetic material comprises polypropylene.

14. A magnetic core inductor comprising:
a cylindrical body with a first radius;
a core section of the cylindrical body positioned at the center of the cylindrical body, the core section having a body that forms a cylinder with a second radius that is smaller than the first radius;
a shell ring section of the cylindrical body surrounding the core section, the shell ring section having a body that forms a hollow cylinder having an inner radius that is smaller than the first radius and larger than the second radius;
a void between the core section and the shell ring section, the void having a radial width that is a difference between the inner radius of the shell ring section and the second radius; and
a conductive coil positioned within the void between the core section and the shell ring section.

15. The self-shielded high frequency inductor of claim 14 further comprising a conductive layer disposed around an outer circumference of the cylindrical body.

16. The self-shielded high frequency inductor of claim 14 wherein the core section comprises a ferrite material.

17. The inductor of claim 14 wherein the shell ring section comprises a ferrite material.

18. The inductor of claim 14 wherein:
the conductive coil comprises a copper wire or a copper foil; and
the conductive layer comprises a copper film.

19. The inductor of claim 14 wherein the conductive coil is wound around the core section in one of: a helical pattern; or a Z pattern.
